(19) United States
(12) Patent Application Publication
(10) Pub. No.: US 2026/0112980 A1
(43) Pub. Date: Apr. 23, 2026

(54) Diode cells for harvesting energy from distributed motions

(71) Applicant: Renyun ZHANG, Sundsvall (SE)

(72) Inventor: Renyun ZHANG, Sundsvall (SE)

(21) Appl. No.: 19/362,475

(22) Filed: Oct. 19, 2025

Related U.S. Application Data
(60) Provisional application No. 63/709,448, filed on Oct. 20, 2024.

(51) Int. Cl. H02N 1/04

(52) U.S. Cl. CPC H02N 1/04

(57) ABSTRACT

An energy harvesting system converts energy from mechanical motion into electrical energy using one or more diode cells each comprising at least one diode having a junction. Each diode cell is placed on or in a carrier. The diode cell(s) then produce an induced current in response to a potential difference across the junction when in proximity to a charged object that has a dynamically changing electrostatic field. The induced current may then be led to a load and/or energy storage component. The diode cell(s) produce the induced current independent of alignment of motion vectors of the charged object with the diode junctions and may be distributed even at non-planar positions within a volume.

### REFERENCE TO RELATED APPLICATIONS

This application claims priority of U.S. Provisional Patent Application No. 63/709,448, filed 20 Oct. 2024.

### TECHNICAL FIELD

This invention relates to devices for harvesting energy from distributed motions.

### BACKGROUND ART

The challenge of harvesting energy from distributed mechanical motions has increased in significance in anticipation of future power sources for small electronic devices and sensors, especially in the context of sustainable power sources and particularly in scenarios where access to conventional power sources is limited, such as in remote areas, wearable electronics, or implanted devices. Technologies that harvest energy from mechanical motions may also increase the operational time of portable electronics and facilitate the development of self-powered systems. Actual implementation of this technology remains, however, difficult from the perspective of feasibility, flexibility, and simplicity.

Triboelectric nanogenerators (TENGs) and piezoelectric generators are two technologies that have been widely studied to harvest energy from mechanical motions such as waves and to serve as high-voltage resource for self-powered systems such as autonomous actuation/digital microfluidic system. See, for example, Huang, T. et al., “Human walking-driven wearable all-fiber triboelectric nanogenerator containing electrospun polyvinylidene fluoride piezoelectric nanofibers”, Nano Energy 14, 226-235 (2014); and Wang, W. et al., “Remarkably enhanced hybrid piezo/triboelectric nanogenerator via rational modulation of piezoelectric and dielectric properties for self-powered electronics”, Appl Phys Lett 116, 023901 (2020). A significant drawback of these technologies, however, is that, to be efficient, they require the alignment of the direction of the motion vectors with the device architecture.

### BRIEF DESCRIPTION OF THE DRAWINGS

FIGS. 1A-1M illustrate the results of experiments that show various characteristics of a diode under a changing electric field.

FIGS. 2A-21, including FIGS. 2B1-2B5, illustrate various experimental results, in particular relating to the performance of diode cells configured according to the invention, obtained for some embodiments of the invention.

FIGS. 3A-3L illustrate various features of embodiments of the invention, in particular, to show the properties of energy harvesting with free motion in space, on a surface, and also a volume effect.

FIG. 4 illustrates that the energy-harvesting system according to the invention may also be configured on curved surfaces.

FIG. 5 illustrates the main components of a practical system implementation according to the invention.

FIGS. 6A and 6B illustrate the distance-dependence of the energy-harvesting devices in different embodiments of the invention.

FIGS. 7-9 illustrate embodiments used to power implanted electronics and as applications in wearable electronics.

FIGS. 10A-10J illustrate embodiments used for spontaneous energy harvesting from one object moving relative to another, in particular, cars and roads.

FIG. 11 illustrates an embodiment in which the energy-harvesting devices of the invention are used for electrostatic position and motion sensing.

### DETAILED DESCRIPTION

In broadest terms, embodiments of this invention provide for harvesting of energy from mechanical movement relative to an electrostatic field using an array of connected diodes that are mounted on or in a carrier. The energy may then be used to power a load such as a device or be stored. An arrangement of Diode Cells—referred to here as a “DiCe”—is employed and exploits the generation of dynamically changing electrostatic fields, which induce a potential difference across diode junctions via electrostatic induction. This innovation facilitates unidirectional charge transport and reduces the sensitivity to motion directionality while manifesting both surface and volume effects. Tests have indicated that a DiCe can achieve a power density of approximately 362 kW/m³; moreover, DiCes are operational in both contact and non-contact modalities, which enables them to be used in a wide range of applications for which conventional technologies are unsuitable or inefficient, such as powering implanted electronics, on curved surfaces, and harvesting energy from objects moving relative to one another, such as vehicles on roads.

As used in embodiments of this invention, a DiCe is a device that guides the electron flow across a diode junction that is caused by the potential difference created by changing electrostatic fields. As one example of the potential efficiency, the power density of a DiCe according to this invention could achieve 362 kW/m³, such that a single-diode DiCe could power 305 LEDs. As another example, a 0.02 m² sized DiCe containing 360 diodes can supply a DC voltage and current of maximum 490 V and 1.08 mA respectively, which equals a DC power density of 26.5 W/m². DiCes have other unique features as well, such as freedom of motion in space and on the surface, as well as the volume effect. Such features allow DiCes to be applied in many scenarios such as powering loads such as implanted devices, and spontaneous energy harvesting from cars and roads. A summary of results of tests of embodiments of the invention in these example scenarios is given below. The DiCes thus open a window for energy harvesting from distributed mechanical motions and provide flexibility, feasibility, and simplicity.

### Electricity Generation on Diodes

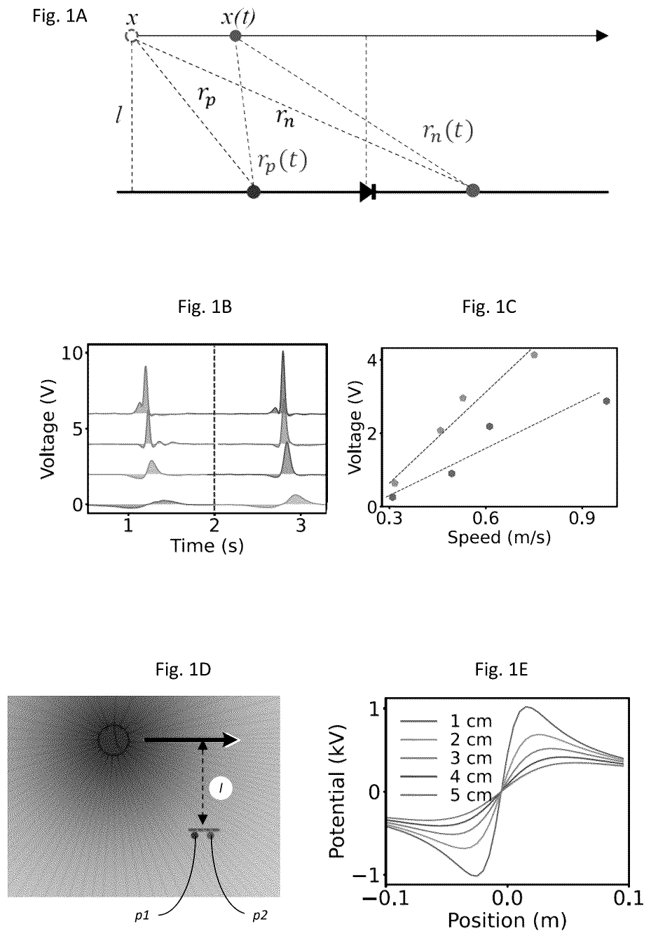

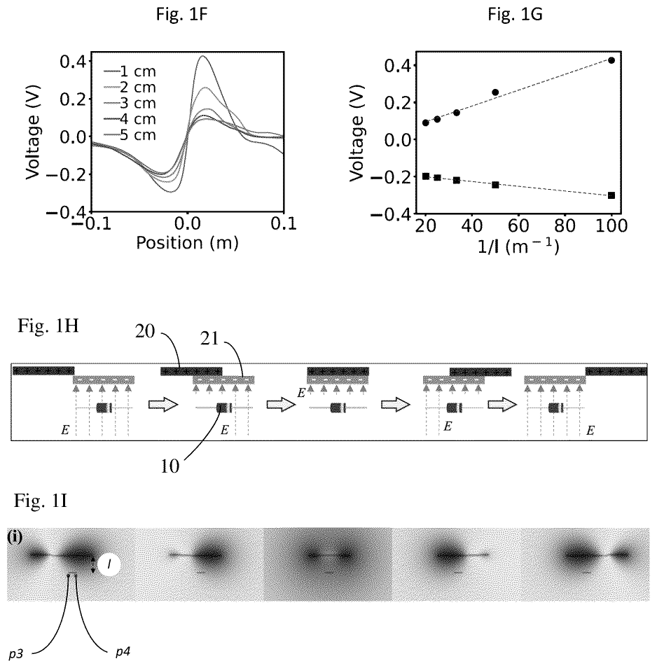

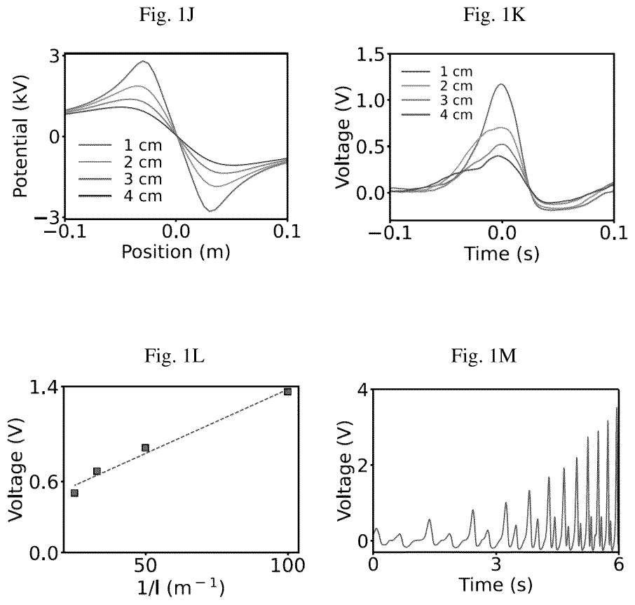

DiCes generate electricity by responding to time-varying electrostatic fields. When a charged object moves near a diode junction, it modulates the electrostatic potential across the junction, inducing a voltage difference. This results in charge transport similar to an externally applied bias. Different types of diodes will have different types of junctions. Common silicon or germanium diodes, as well as Zener diodes, have p-n junctions whereas, for example, Schottky diodes have m-s (metal-semiconductor) junctions. Any diode type may be used in implementations of the invention. The experimental results shown below were obtained for silicon and germanium diodes with p-n junctions; other diode types may generally have different quantitative results, but will qualitatively be the same, that is, will all exhibit induced current in the presence of the dynamic electrostatic field. FIG. 1A shows a diagram of a point charge moving parallelly to a DiCe containing only one diode at a vertical distance of I. This principle is illustrated using a point charge in because the distribution of its electrostatic field is well defined, which makes it easier to understand the mechanism underlying embodiments of the invention.

The point charge creates a potential difference across the diode junction via electrostatic induction. The electrostatic potential (P) difference across the junction due to point charge (q) can be calculated by:

$$ΔΦ = {Φ}_{p} ( {r}_{p} , t ) - {Φ}_{n} ( {r}_{n} , t ) = \frac{q}{4 πϵ} [ \frac{1}{\vert {r}_{p} - {r}_{q} ( t ) \vert} - \frac{1}{\vert {r}_{n} - {r}_{q} ( t ) \vert} ] \qquad ( 1 )$$

where r_{q}(t) is the position of the moving charge at time t; rₚ and rₙ are the positions where the potential at the p and n side of a diode; and ε is the permittivity of the surrounding medium. If the point charge is moving at a speed of v, the induced potential over the junction (Vₚₙ(t)) can be given by:

$${V}_{pn} ( t ) = \frac{q}{4 πϵ} [ \frac{1}{\sqrt{{( x - \frac{d}{2} - vt )}^{2} + {l}^{2}}} - \frac{1}{\sqrt{{( x - \frac{d}{2} - vt )}^{2} + {l}^{2}}} ] \qquad ( 2 )$$

where x is the initial lateral position of the charge to the middle of a p-n junction, dis the width of the depletion layer (d=1 μm), e is the permittivity of air. If Vₚₙ(t) is the same as the forward bias direction, it will not exceed the forward bias limit. If the diode is in a circuit, the current I(t) can be expressed by:

$$l ( t ) = \{ \begin{matrix}C \frac{{dV}_{pn}}{dt} , & if 0 < {V}_{pn} < {V}_{f} \\ \frac{{V}_{f}}{{R}_{s}} , & if {V}_{pn} \geq {V}_{f} \\ M ( {V}_{pn} ) C \frac{{dV}_{pn}}{dt} , & if {V}_{pn} \leq - {V}_{br}\end{matrix} \qquad ( 3 )$$

where C is junction capacitance; V_{f} is the forward bias threshold; V_{br} is the breakdown voltage; R_{S} is the resistance of the circuit; and M(Vₚₙ) is the avalanche multiplication factor. For a DiCe that contains N_{d} serially connected diodes, the voltage can be expressed as

$${V}_{Dice} = {\sum }_{i = 1}^{{N}_{d}} {V}_{pn}^{( i )} , \qquad ( 4 )$$

and equation (3) can be revised as:

$${l}_{Dice} ( t ) = \{ \begin{matrix}{\sum }_{i = 1}^{{N}_{d}} C \frac{{dV}_{pn}^{( i )}}{dt} , & if 0 < {V}_{pn}^{( i )} < {V}_{f} \\ {N}_{d} \frac{{V}_{f}}{{R}_{s}} , & if {V}_{pn}^{( i )} \geq {V}_{f} \\ {\sum }_{i = 1}^{{N}_{d}} M ( {V}_{pn} ) C \frac{{dV}_{pn}^{( i )}}{dt} , & if {V}_{pn}^{( i )} \leq - {V}_{br}\end{matrix} \qquad ( 5 )$$

FIGS. 1A-1M are described briefly above. These figures illustrate the findings of experiments used to test the foundations of embodiments of the invention, but also illustrate how different embodiments may be applied to create many practical applications when implemented in devices. A more complete description of these figures is as follows:

FIG. 1A: A sketch of the generation of electricity on a diode by moving a charged object 20 (in the illustrations and as used in some experiments, a charged PVC tube) over the diode, where l is the vertical distance between the diode and the charged object. x is the lateral position of the charged object to the middle of the diode's junction. x(t) is the lateral position at time t. Values rₚ and rₙ are the distances of the charged object to the p and n side of the diode, respectively, an rₚ(t) and rₙ(t) are the distances of the charged object at time t.

FIG. 1B: A plot of the measured voltage over the diode while moving the charged PVC tube at different speeds. The dashed line in the middle separates the moving directions from left to right (left side of the dashed line) and from right to left (right side of the dashed line). In one experiment, the charge density of the PVC tube was 13.45 mC/m² and vertical distance (l) was 0.5 cm.

FIG. 1C: A plot of the maximum voltage versus the moving speed of the PVC tube, showing a linear relationship.

FIG. 1D: Simulated electrostatic field of a charged circle at different values of l.

FIG. 1E: Simulated potential at points p1 and p2 in FIG. 1D (with 1 μm separation between, which is the thickness of the diode's depletion layer) versus the position of the charge circle.

FIG. 1F The measured potential difference versus the position of a charged PVC tube.

FIG. 1G: A plot of the potential difference versus 1/l.

FIG. 1H: A schematic drawing shows the change of electrostatic field E on a diode 10 due to the in-situ generated triboelectric charge by rubbing one dielectric material 20 on another one 21.

FIG. 1I: The potential at the points p3, p4 (0.001 mm separation) versus the distance between the diode and the dielectric material.

FIG. 1J: The difference in potential of the two points p3, p4 versus the position of the slider (positive charged) in the simulation.

FIG. 1K: The measured potential difference versus the position of the slider. In this case a piece of polyurethane (3 cm×5 cm) was rubbed on a polymethyl methacrylate plate.

FIG. 1L: A plot of the potential difference versus 1/l.

FIG. 1M: The measured potential at different speeds of rubbing.

To summarize, FIGS. 1A-1M represent different phenomena that arise when a diode moves in a changing electric field. Embodiments of this invention take advantage of these phenomena to provide a particularly efficient and direction-independent diode arrangement for harvesting electric energy.

### Energy Harvesting Using Diode Cell (DiCe)

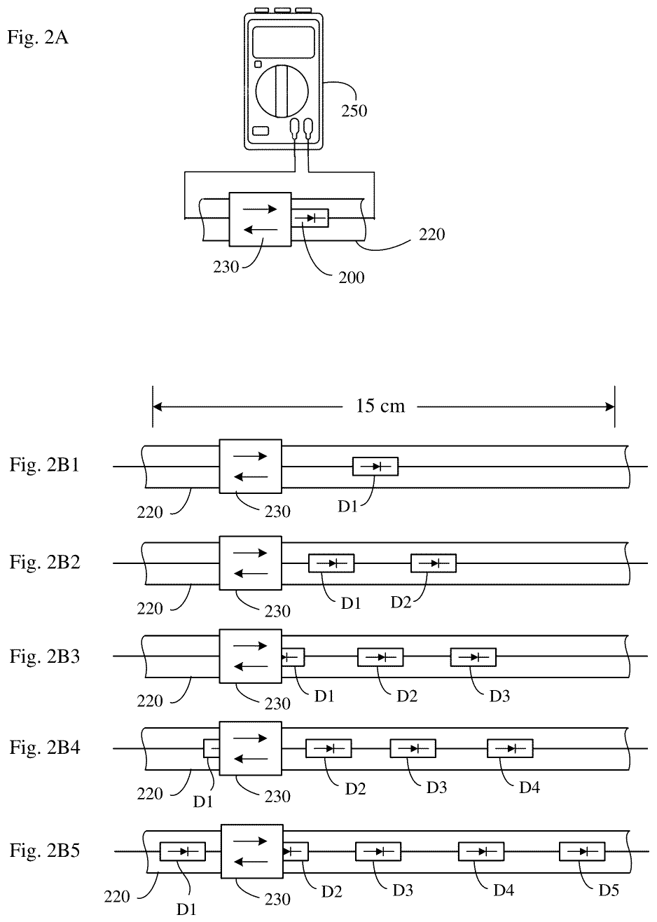

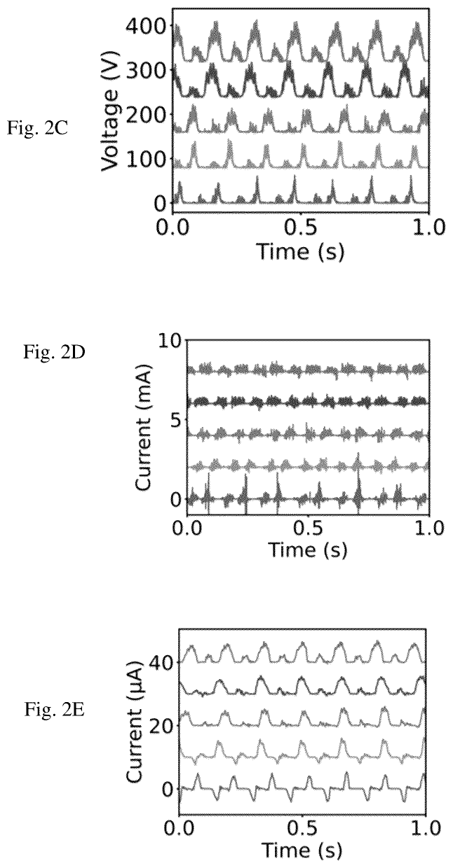

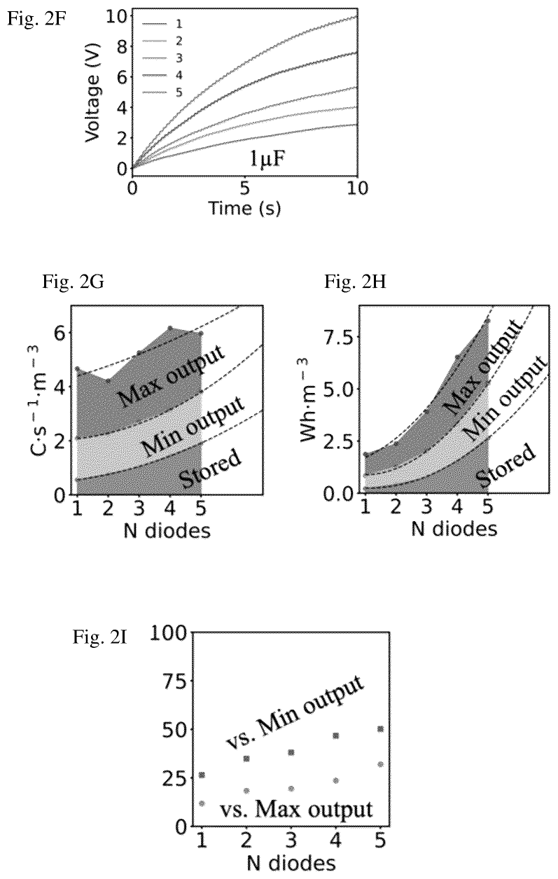

FIG. 2A illustrates an embodiment in which a circuit in which the two terminals of a diode 200 were connected using a multimeter 250 to implement an in-situ charge generation method to induce a dynamically changing electrostatic field. The diode 200 was encapsulated within a polytetrafluoroethylene (PTFE) tube 220 (shown cut away, so the diode is visible), the diode 20 serving as a DiCe (FIG. 2A). A piece of cotton 230 was then rubbed back and forth on the PTFE tube 220, thereby causing a variable electrostatic field through contact electrification.

For comparative analysis, multiple DiCes were fabricated, each with varying numbers of DiCes, that is, diodes (d1-d5) serially connected (FIGS. 2B1-2B5, with the diodes, respectively) spaced over 15 cm.

Experimental results revealed (with the results shown for the five-diode configuration uppermost, for the single-diode configuration as the bottom line, and for the two-four diode configurations respectively arranged in increasing order between) that the open circuit voltages (FIG. 2C) of the different DiCe configurations exhibited a direct-current (DC) nature, attributable to diode modulation. As the rubbing motion occurred back-and-forth at a frequency of 7 Hz, voltage signals were observed as peaks. Both the intensity and width of these peaks demonstrated a correlation with the number of diodes in the DiCe, revealing a non-linear relationship for intensity and a linear relationship for peak width. It was observed that the peaks of multiple diodes represented an overlay of signals from individual diodes within the DiCe, which tended to explain the linear relationship of peak width with the number of diodes.

It was also found that the maximum short circuit current of the DiCes could reach milliampere levels (FIG. 2D) and that the current signals contain peaks at both high-frequency and low-frequency domains. High-frequency signals were attributable to electrostatic discharge during the contact electrification process, which occurs consistently. Conversely, low-frequency signals, observed after filtering out high-frequency components (FIG. 2E), were attributable to electrostatic induction and demonstrated greater stability. Notably, DiCes with one or two diodes exhibited AC current signals, while those with three or more diodes displayed DC signals. This behavior correlated with source-drain characteristics of the DiCes, and indicated an increase in forward bias with an escalating number of diodes.

The energy outputs from the above-mentioned five DiCes were evaluated by charging a 1 μF capacitor for 10 s (FIG. 2F). Results indicated that the energy stored in coupled capacitors was proportional to the number of diodes in the DiCes. For a DiCe with five diodes, the charges stored in a 1 μF capacitor after a 10 s charging process could reach a value over 1.8 C·s⁻¹/m³ (FIG. 2G), corresponding to 2.5 Wh/m³ (FIG. 2H). The DiCe used in the experiment whose results are shown in these figures was 15 cm long, which, using typical diodes, would be enough space for at least 10 diodes, which implies that their combined energy output could reach above 10 Wh/m³ based on the fitted curve for the energy stored in the capacitor.

The output power of the single-diode DiCe was found in the illustrated experiment to reach a maximum value of 680 mW, which equals 362 W/m² if the surface area of the PTFE tube (radius=2 mm) was taken into account, which is also equal to 362 kW/m³ if the volume was taken into account. If the high-frequency signal was filtered out, the power was reduced to 10.5 mW, which equals 5.6 W/m² and 5.6 kW/m³, respectively. These results represent those obtained using a prototype, experimental design, corresponding to one embodiment, but should not be taken as being limitations of other implementations that use the same basic structure of series-connected, diodes. For example, with an optimized power management system, more energy may be stored—the efficiency (FIG. 2I) of energy storage in an un-optimized system was measured to be below 50% compared to the minimum output of the DiCe, and the number was about 30% if compared to the maximum output.

The above-described results have shown that even a single-diode DiCe is capable of providing a relatively high output power. The power output was further demonstrated in one test by powering 305 LEDs with a single-diode DiCe. Taking advantage of the current modulation characteristic of diodes, a DiCe with close loops of LEDs was powered enough to light up by rubbing the backside of a PTFE film attached to the DiCe with a piece of cotton.

To summarize, FIGS. 2A-2I illustrate some characteristics and the performance of DiCes, which embodiments of this invention take advantage of. Thus:

FIG. 2A: A schematic drawing of a DiCe with serially connected diodes (one shown). The diodes were placed inside a PTFE tube (diameter: 4 mm) and a piece of cotton was wrapped on the tube.

FIG. 2B: Operation of DiCes with different numbers of serially connected diodes. A piece of cotton (3 cm) was rubbed on the PTFE tube.

FIG. 2C: Open-circuit voltage measured on the DiCes. The order of the signals corresponds to the order in FIG. 2B.

FIG. 2D: Short circuit current measured on the DiCes.

FIG. 2E: Short circuit current measured on the DiCes after filtering the high frequency signals.

FIG. 2F: Voltage measured on a 1 μF capacitor charged with the DiCes.

FIG. 2G: Charge generation of the DiCe per second at a volume of 1 cubic meter.

FIG. 2H: Energy output from the DiCe per cubic meter.

FIG. 2I: Efficiency of energy storage versus min and max energy output on the DiCes.

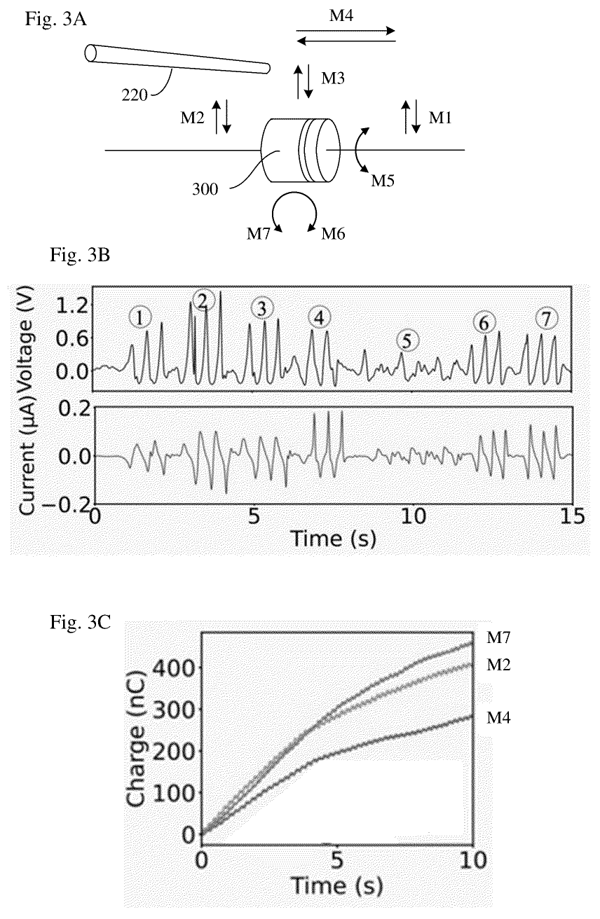

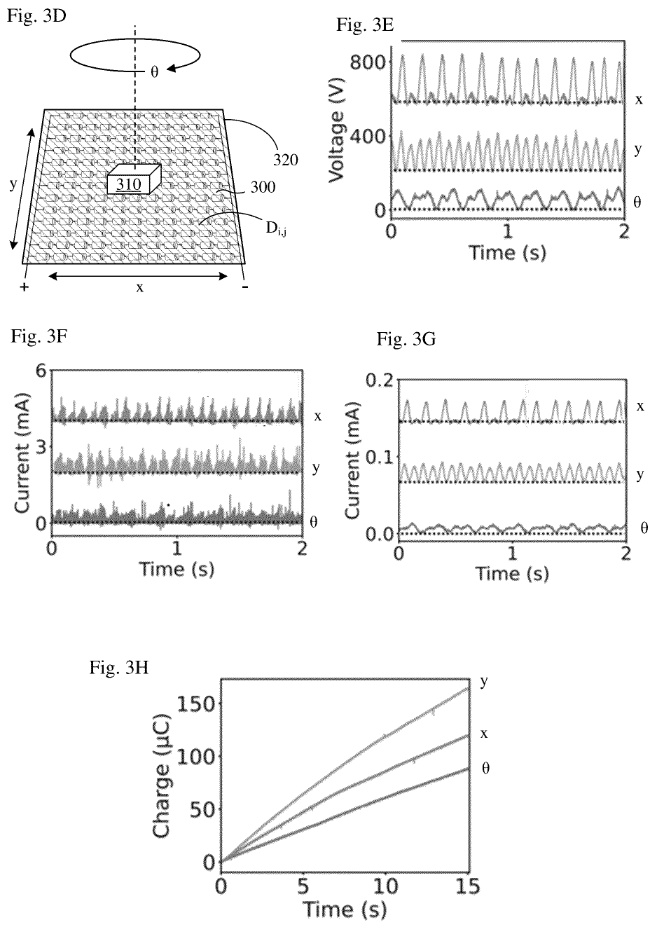

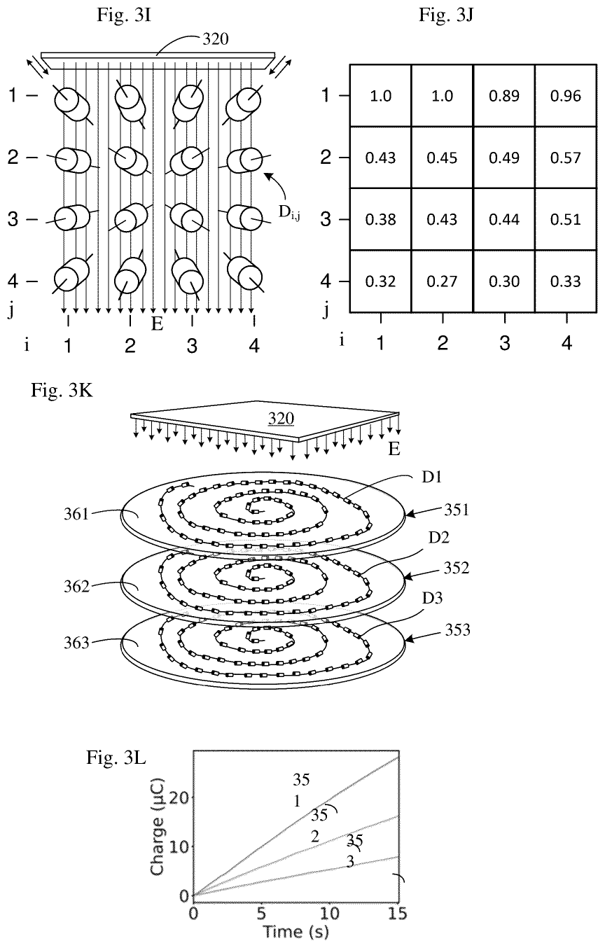

FIGS. 3A-3H illustrate some of the unique features of the DiCes, in particular, in the case of free motion in space and on a surface. Electrostatic induction serves as the fundamental physical principle underpinning DiCes. This is a concept that is also exploited in triboelectric nanogenerators (TENGs). Unlike TENGs, however, where efficacy relies heavily on the meticulous alignment of motion vectors and device architectures, such constraints do not limit the operational versatility embodiments of DiCes.

FIG. 3A illustrates seven distinct motions relative to the charged object 220, both translational and rotational, labelled M1-M7 that are capable of inducing electricity generation even within a single-diode DiCe 300. Experimental results have demonstrated that unrestricted motions of a charged object 220 in the space surrounding a DiCe efficiently convert mechanical energy into electricity, as illustrated by the graphs of generated voltage and current shown as FIG. 3B in which the labelled peaks correspond to the same-numbered motion directions in FIG. 3A (for example, peak 2 corresponds to M2, and so on.). As described in various example use cases below, the charged object 220 may be of very many different types, from a deliberately statically charged rod or tube, to clothing that develops a static charge as the wearer moves, to vehicles passing over DiCes embedded in a road surface, and many more,

FIG. 3C illustrates the charges generated by three different ones (motions M2, M4 and M7) of the motions used to charge a 1 μF capacitor. FIG. 3C thus illustrates the ability of the diode structure of even a single DiCe to efficiently harvest energy.

Whereas the ability of TENGs to generate energy is direction-dependent, specifically, only when a dielectric material slides over it back-and-forth along a single line, embodiments of the DiCe arrangement can move freely on the counter dielectric material's surface. FIG. 3D illustrates a piece of cotton 310 being rubbed on the diodes D_{i,j} of a DiCe array 300. In this example configuration, the diodes D_{i,j} are shown as being arranged as 13 parallel connected rows of eleven series-connected diodes each, covered by a PTFE film 320 to act as the charged object 320. This is of course just by way of example; the number and arrangement of the diodes are design choices that skilled electrical engineers will know how to make for any given implementation of the invention. In some experiments conducted by the inventors, for example, a 10×34 array was used, tested both with and without the film 320. The symbols + and − are included to represent the voltage “terminals” formed by the conductors that connect the diode rows in parallel; similar conductors will naturally be included for other DiCe arrangements, as skilled electrical engineers will realize-such conductors are needed to lead the generated current to whichever device or storage system the DiCe is intended to generate energy for.

As FIG. 3D illustrates, movements of the cotton could be aligned with (x-direction), perpendicular to (y-direction) the direction of the diode connection, or circular (θ-direction, on the surface). DC voltages (FIG. 3E) and current (FIGS. 3F and 3G) were observed on the 11×13-diode array while being operated through all the three motions, where FIG. 3G shows the result after filtering of high frequency signals. FIG. 3H illustrates the result of charging a 1 mF capacitor with the DiCe subjected to different movements. Remarkably, even without circuit optimization, the charge stored in the capacitor after 15 s exceed 150 μC (FIG. 3H), closely approaching the state-of-the-art output from TENGs with optimized power management.

FIGS. 3I-3L illustrate other advantageous properties of a DiCe, in particular, its volume effect—the DiCe diodes do not have to be arranged in a plane, although this is of course an option, depending on the chosen implementation. Beyond the free motions in space and on surfaces discussed above, DiCes also exhibit the capability of being able to be stacked to harvest energy from a dynamically changing electrostatic field E, thereby providing a volume effect. In FIG. 3I, the lines indicating the electrostatic field E are parallel, which is a possibility, but is done here simply for the sake of simplicity. One advantage of embodiments of the invention is that this is not a requirement for them to work effectively—in most cases, the “field lines” (a known abstract representation of the continuous electrostatic vector field) will not be parallel. In embodiments, the electrostatic field is in any case dynamic, changing with or without relative motion between the charged object and the DiCe. As for “without relative motion”, note that an electrostatic field might change even on a stationary charged object if the charge itself changes on that object.

To demonstrate this effect, as illustrated in FIG. 3I, in an experiment a 4×4 diode array was fabricated, and the voltage across the diode array was measured while being exposed to a moving electrostatic field above the array, such that diodes in row 4 are farther from the charged object 320 than those in rows 1-3. As the figure illustrates, this also involves relative motion of the charged object not parallel to the plane in which the diodes D_{i,j} are mounted FIG. 3J depicts a heatmap of the normalized voltage measured on each diode, indicating reduced charging generation with increased distance from the electrostatic field.

Further substantiating the volume effect, and illustrating yet another category of embodiments, three DiCes 351, 352, 353 (each comprising serially connected diodes D1, D2, D3 connected in series as a spiral and mounted on any non-conductive substrate 361, 362, 363) were fabricated and stacked on top of each other (FIG. 3K). Of course, in other embodiments, any number of DiCe “layers” or “cells” may be used, and the number of diodes in each DiCe is also a design option. The different DiCes may be connected in series or in parallel, depending on the application. The surface of the top DiCe 351 was cover by PTFE film (in one embodiment, by tape), and a piece of cotton was used to generate an in-place electrostatic field E on the charged object 320. By rubbing a piece of cotton on the PTFE film (here, the charged object 320) covering the top DiCe, charges were generated on the three cells and stored by charging a 1 mF capacitor. Results (FIG. 3L) revealed that the total charges stored by all three DiCes were twice that using only one DiCe, thus demonstrating a volume effect.

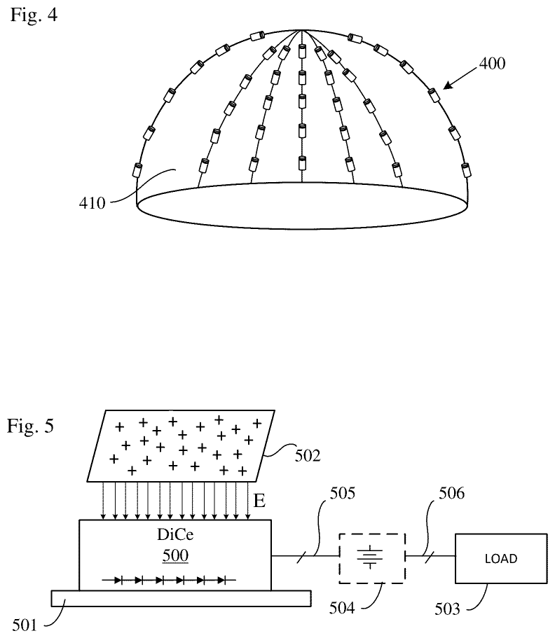

FIG. 4 illustrates yet another advantageous characteristic of embodiments of the invention that derive from the directional independence of the DiCe: the diodes of the DiCe 400 can harvest energy even when they are arranged on a curved surface 410. In the figure, the diodes are arranged in semi-circumferential “strands”, topologically similar to the array depicted in FIG. 3D (with one end of each row joined in a point) but this is merely by way of illustration; the diodes may be arranged however the system designer prefers. To illustrate this advantage, if the DiCe is configured on a non-planar, curved substrate 410 such as hemispherical substrate shown in FIG. 4, and thanks to the volume effect of the invention, regardless of how the electrostatic field moves relative to the DiCe, there will be some diodes at an orientation to produce maximum output.

FIG. 5 depicts a generalized implementation of the invention: A DiCe 500, which may comprise any number of diodes in any desired configuration, is mounted on or in any chosen carrier 501. When exposed to the dynamic electrostatic field E of a charged object 502, current that arises in the DiCe 500 generates current that is applied to a load 503 such as a device, optionally via a storage component 504 such as one or more capacitors, a battery, etc., in which case the storage component 504 itself could be considered to be the load 503. Current produced by the DiCe 500 may be carried to the storage component 504 and/or to the load 503 over any known conductors 505, 506, such as those depicted with the + and − terminals in FIG. 3D. In one tested implementation, for example, a DiCe was able to power LEDs directly, with no need for intermediate energy storage. Different implementations will require different carriers, depending on which DiCe configuration is needed to power a chosen device. The nature of the charged object will also vary depending on the implementation. In some cases, the charged “object” is the DiCe's environment itself as opposed to a specific physical object. Furthermore, the “charged object” 502 may receive its charge through contact with or influence of some other object, or because of internal factors.

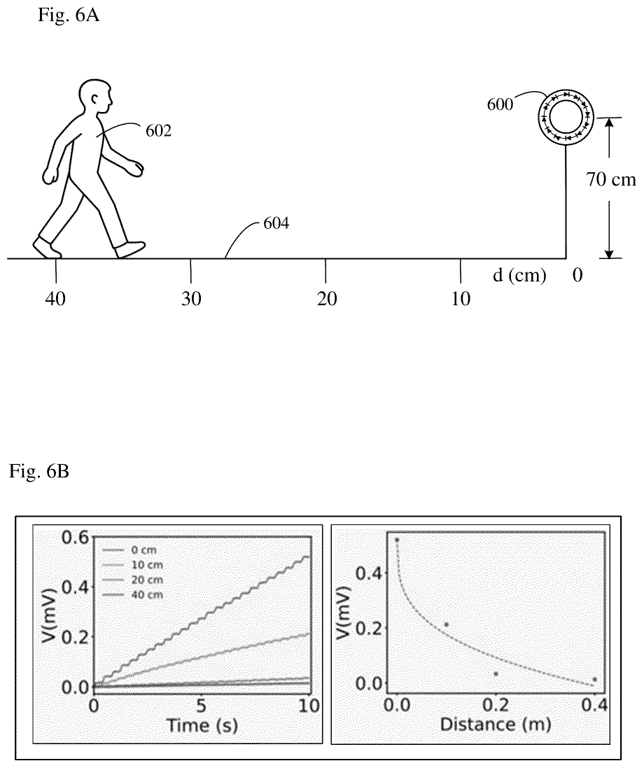

See FIGS. 6A and 6B, which illustrate an embodiment in which a DiCe 600 harvests energy even at a distance to a charged moving object 602. In the illustrated embodiment, the DiCe 600 is configured as a loop of series-connected diodes mounted 70 cm above floor level and the moving object is a person who is walking towards the DiCe. In this embodiment, the DiCe takes advantage of the spread of the electrostatic field over both space and distance. In testing this embodiment, a 1 μF capacitor was charged up by the DiCe 600, who was stepping on a floor 604 at different distances to the DiCe. Here, the electrostatic field will be created from the movement of the person's clothing, by the contact and friction between the person's shoes and the floor 604, etc. FIG. 6B is a plot of the voltage on the capacitor as a function of time (left graph) and of distance (right graph), measured over a 10 s time interval.

The capacitor was charged to 0.21 mV at a distance of 0.2 m, compared to 0.52 mV when the DiCe 600 was put in the person's pocket as he walked. FIG. 6B (right side) also shows that there is a nonlinear relationship between the voltage and the distance.

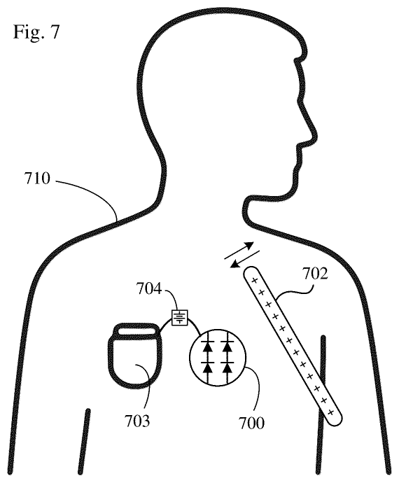

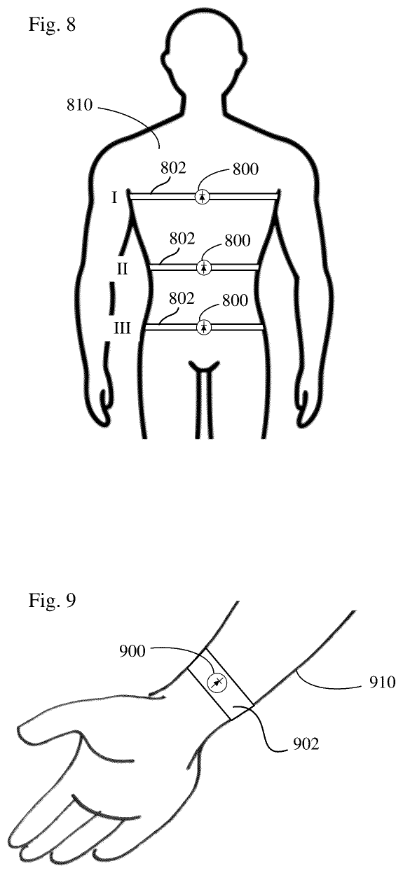

Embodiments of the invention may be used to advantage in many different scenarios, in many of which the directional limitation of other arrangements such as TENGs will make them unsuitable for use in harvesting energy. FIGS. 7 and 8 illustrate two such scenarios, that is, the powering of implanted electronics and applications in wearable electronics.

FIG. 7 depicts (not to scale) the movement of a charged PVC tube 702 (the “charged object” in this example) near and over a DiCe 700 that is electrically connected to a current storage device 704, which supplies energy to a device 703 that is implanted in a patient 710. Depending on the storage device 704, the storage device 704 may be omitted and the DiCe can then drive the load (in this case, the device 703) directly. The DiCe 700 may itself be implanted in the patient, within any suitable casing, or may be secured on the patient's body or on some wearable item that holds the DiCe. In implementations in which the DiCe 700 and/or storage device 704 is not implanted, the conductor that leads the current it generates may be arranged to pass into the patient's body in any known manner. The energy storage device 704 may be advantageous to store electrical energy generated by the DiCe 700, for example, when the device 700 doesn't actively require it for operation. Energy may be generated by waving the charged object 702 back and forth over and preferably as close as possible to the DiCe 700.

Instead of the charged rod as the charged object, one could also implement other charge-generation methods, for example, rubbing two dielectric materials above the place where the device is implanted. Compared to known wireless strategies for charging implanted devices, the wireless charging capability of the invention is both simpler and has a higher accessibility.

### Wearable Energy Harvesting Devices

An adult of average height and weight consumes approximately 2000 kcal of energy per day, of which roughly 24-32% is due to physical movement, equaling an average of about of 2.34 MJ. In another prototype of an embodiment of the invention, depicted in FIG. 8, a series-connected array 800 of DiCe elements was configured as a strap 802 (forming the carrier 501) and worn on either the chest, belly or waist (shown as positions I, II and III respectively), to harvest energy from body movements, in particular, the movement of respiration, which also causes clothing to move and rub against the body as well as itself. Measurements showed that the belt was able to generate about 40 nC in 60 seconds, which equals roughly 1.15 μJ per day. Note that this embodiment also illustrates another advantage of the invention: the carrier on which the energy-harvesting DiCe cells are mounted may also be flexible—because of the directional independence of the diode cells the diodes they comprise do not need to be (but may be, if preferred) fixed in a single plane or in a single line.

DiCe elements can be configured on or in other wearable items as well. FIG. 9, for example, illustrates an embodiment in which a DiCe element 900 is mounted on a wrist band 902 on a user's wrist 910. In a tested prototype the wrist-borne DiCe harvested energy while the user was walking. In 60 seconds at a frequency of 2 steps/second, a 1 μF capacitor was charged to about 1.8 V.

Note that these embodiments are examples that show another significant advantage of the invention: Because a DiCe does not require alignment of the direction of the motion vectors of the charged objects with the device architecture, in particular, with the diode(s)' junction(s), they can be mounted on non-linear carriers such as straps around non-linear surfaces such as a person's chest, legs, wrist or other body parts, as well as on non-linear surfaces of other objects, and each diode in the structure (preferably series-connected) will be able to contribute energy that can be harvested.

These embodiments also show that it is not necessary to have specialized devices such as charged rods to cause the DiCe devices to harvest energy; rather, a sufficient electrostatic field may in many cases be generated by the contact between layers of a wearer's clothing, or between the wearable devices and the user's clothes, etc., or between layers of the carrier itself, such as a belt, strap, bracelet, etc.

Spontaneous Energy Harvesting from Vehicles on Roads

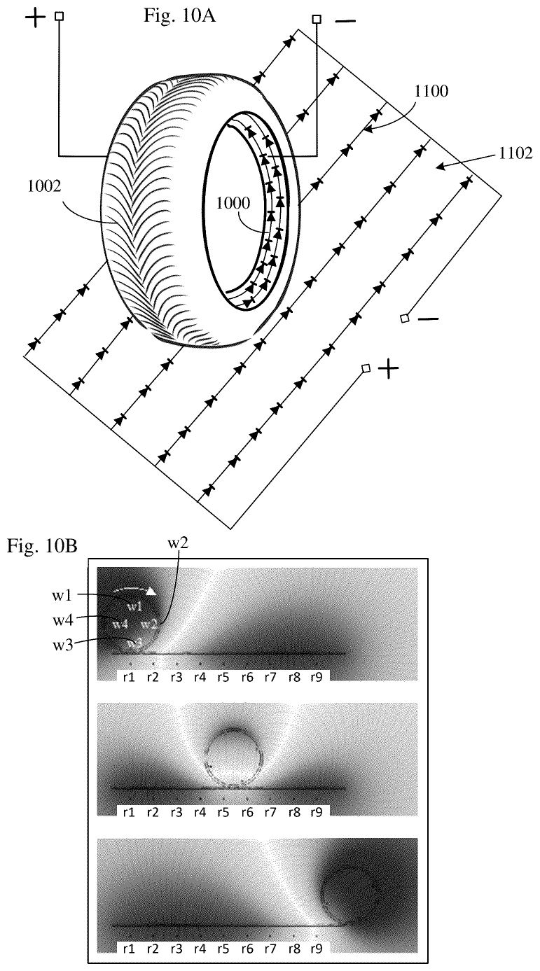

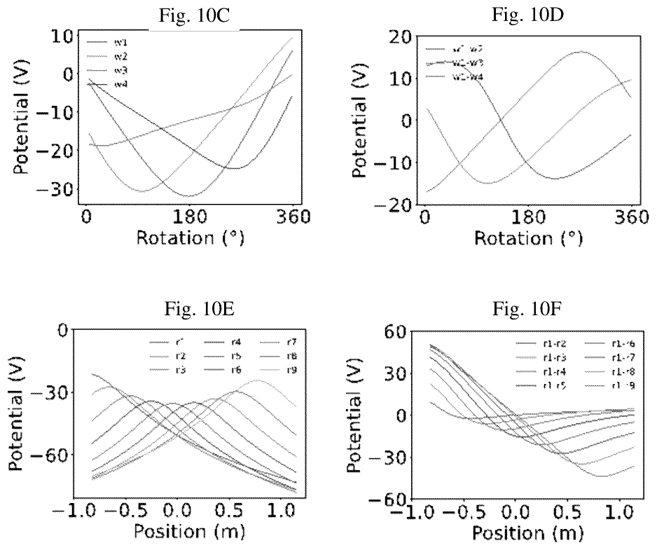

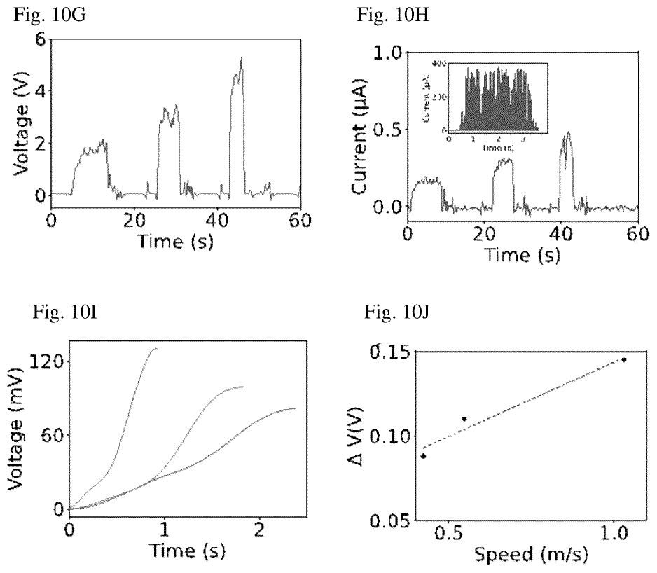

The invention is not limited to use with humans. Since a DiCe is a type of energy harvesting device that, unlike TENGs, requires no displacement of components, no mechanical work needs to be done on a DiCe. This makes it especially easy to integrate the invention with other objects. DiCes could, for example, be mounted inside car tires and under a road to spontaneously harvest energy while a car is running on them. Under ideal conditions, an electric car can recover about 10% of the energy lost on rolling resistance. This embodiment is illustrated in FIG. 10A, in which a first DiCe array 1000 is mounted within a tire 1002 and a second DiCe array 1100 is mounted in the surface of a road 1102.

To test these embodiments, the DiCe 1100 was mounted under a Teflon tape to mimic a road and the other DiCe 1000 was mounted inside the car tire 1002. The electrical signals from both of the DiCes 1000, 1100 was measured to verify the simulation results. Note the conductors and terminals, marked as is conventional by + and −.

FIG. 10B shows a representation of the electrostatic fields of a simulation of the tire 1002 tire rolling on the road, where w1-w4 and r1-r9 show the positions where electrostatic potentials were measured. FIG. 10C shows a plot of the electrostatic potential on four positions inside the tire, where, from top to bottom at the right side of the graph, the curves correspond to w2, w1, w3 and w4, respectively. FIG. 10D is a plot of the potential difference of w2, w3 and w4 to w1. Such a difference could drive electron flow over a DiCe.

FIG. 10E is a plot of the electrostatic potential at the nine positions on the road as shown and FIG. 10F illustrates the potential difference of r2-r9 to r1. The open circuit voltage and the short circuit current at different tire rolling speeds with 20 kg load on the tire are plotted in FIGS. 10G and 10H, respectively; the insert in FIG. 5H shows the current before the filtering of high-frequency signal. FIG. 101 is a plot of the charge harvested to a 1 μF capacitor by the tire-mounted DiCe and FIG. 10J is a plot of the voltage increase per second at different tire rolling speeds.

To study the energy output, the inventors charged a 1 μF capacitor with the road-mounted DiCe 1100 and tire-mounted DiCe 1000 (both need not be included) embodiments at different tire rolling speeds and load weights. Results showed that the charging speeds are proportional to the speed of the tire rolling.

Test results were based on an estimation of the energy output of a car rolling at a speed of 100 km/h under ideal conditions. If one assumes that the contact electrification between the tire and the road is at least roughly the same as the tire and Teflon in the illustrated experiment, and the co-efficient between the impact of speed and weight is 1, the tire-mounted DiCe 1000 of a car could generate 159 kWh energy in one hour and the road-mounted DiCe 1100 could generate 61.6 kWh. Such values equal approximately 4.6-6.9% and 1.8-2.7% of the energy loss of an electric car on rolling resistance, respectively.

In conclusion, as the above description shows, the diode cells (DiCes) used in embodiments of the invention to harvest energy from distributed mechanical motions addresses the growing need for alternative power sources.

### Electrostatic-Based Spatial Position Sensing and Motion Trajectory Tracking

Recall from the discussion above the strength of voltage/current generated by a DiCe (wither single-diode or in an array of any configuration) depends not only of the local strength of the dynamic electrostatic field in which is located, but also on the distance to the charged object that creates the field. These facts are used in other embodiments to achieve precise tracking of an object's position and trajectory in multi-dimensional space, that is, in both two-dimensional (2D) and three-dimensional (3D) spaces. The system employs DiCes, that is, sensor diodes, placed at known, fixed positions (corners or boundaries) about a 2D or 3D sensing area to detect induced electric potentials from a charged or electrostatically active object. Based on these sensor readings, the real-time position and movement trajectory of the object can be accurately computed.

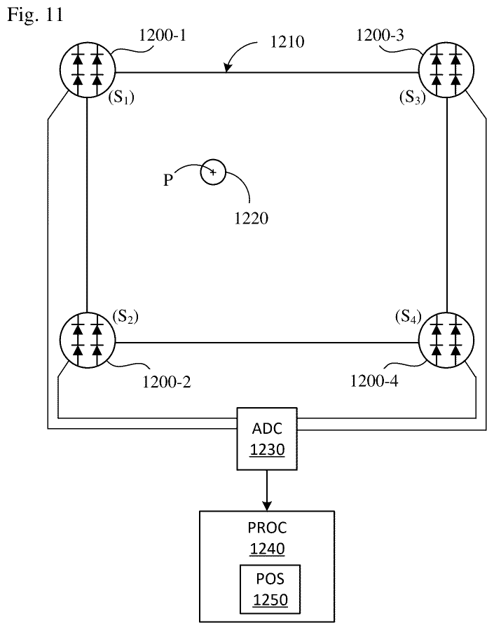

FIG. 11 illustrates a 2D version of this embodiment, in which four sensors, that is, DiCes 1200-1, . . . , 1200-4, are located at the corners of a 2D space 1210. Note that the space does not have to be enclosed or have defined boundaries—this is shown merely to simplify the explanation, which can be extended to arbitrary 2D spaces with only knowledge of high school level geometry and algebra. The only requirement is that the coordinates of the positions of the DiCes are known. A charged object 1220 is located and moves within the space.

When a charged or electrically active object is placed within a conductive or sensing space, it produces an electrostatic field radiating substantially symmetrically from its surface. According to the principle of electrostatic induction, the presence of the charged object induces potential variations in nearby conductive sensors or electrodes, generating measurable electric signals. In the context of this invention, this means that, as in other embodiments, any change in this field will induce a current in the diodes of a DiCe. Assuming identical DiCe elements (not necessary, but this simplifies implementation and computation), the strength and pattern of these signals at the sensors depend directly on the magnitude of the charge on the object; the position of the object relative to sensors; and the geometrical arrangement and number of sensors. Put simply, other factors being equal, the closer the charged object is to a sensor, the stronger its induced current will be and the greater its output value will be. The differences in measured output signal strength can then be used for “multilateration”, that is, the generalized version of “triangulation” in which position is determined from three or more known points.

Assume by way of example an x-y coordinate. In the 2D scenario depicted in FIG. 11, there are four sensors arranged at the corners of a square region with known coordinates:

$${S}_{0} ( {x}_{0} , {y}_{0} ) , {S}_{1} ( {x}_{1} , {y}_{1} ) , {S}_{2} ( {x}_{2} , {y}_{2} ) , {S}_{3} ( {x}_{3} , {y}_{3} ) ,$$

This is by way of example only: To fix position and determine motion, there should be at least three sensors, and there may be more than four. The charged object 1220 is located at an unknown position P(x,y) induces a measurable potential Vᵢ on the sensor located at Sᵢ.

In the 2D case, the relationship between induced potential and distance is given by Coulomb's law for electric potential V:

$${V}_{i} = k \frac{Q}{{r}_{i}} where$$

$${r}_{i} = \sqrt{{( x - {x}_{i} )}^{2} + {( y - {y}_{i} )}^{2}}$$

Vᵢ is the measured potential at sensor Sᵢ.
k is Coulomb's constant (8.99×1098.99\times 10\hat{ }9 8.99×109 Nm²/C²).
Q is the charge on the object (assumed constant, but unknown).
rᵢ is the Euclidean distance from the sensor Sᵢ to the charge at (x,y).

To eliminate any unknown charge Q, signals are preferably normalized by taking ratios or relative intensities between sensors, such as:

$$\frac{{V}_{i}}{{V}_{j}} = \frac{{r}_{i}}{{r}_{j}}$$

With at least three sensors, the following nonlinear equations are generated:

$$\frac{{V}_{0}}{{V}_{1}} = \frac{\sqrt{{( x - {x}_{1} )}^{2} + {( y - {y}_{1} )}^{2}}}{\sqrt{{( x - {x}_{0} )}^{2} + {( y - {y}_{0} )}^{2}}} ,$$

$$\frac{{V}_{0}}{{V}_{2}} = \frac{\sqrt{{( x - {x}_{2} )}^{2} + {( y - {y}_{2} )}^{2}}}{\sqrt{{( x - {x}_{0} )}^{2} + {( y - {y}_{0} )}^{2}}}$$

These equations can be solved numerically using least squares optimization methods to obtain the real-time coordinates (x,y) of the object 1220.

The 2D method may be generalized to 3D spaces as well, in which case at least four, and preferably more, sensors not all in the same plane are required. Assume an x-y-z-coordinate system and also assume by way of simple example that the space is a cube. A DiCe sensor may then be placed at each of the eight corners of the cube. The coordinates of the sensors will then be: Sᵢ(xᵢ, yᵢ, zᵢ), i=0, 1, . . . , 7. A charged object at unknown coordinates P(x,y,z) will induce potentials Vᵢ at sensors Sᵢ

Similar to the 2D model, the induced potential at sensor Sᵢ due to the charged object is given by Coulomb's Law for potential:

$${r}_{i} = \sqrt{{( x - {x}_{i} )}^{2} + {( y - {y}_{i} )}^{2} + {( z - {z}_{i} )}^{2}}$$

To remove dependence on any unknown charge Q, the system may again rely on ratios or relative intensities:

$$\frac{{V}_{i}}{{V}_{j}} = \frac{{r}_{i}}{{r}_{j}}$$

With at least four sensors, the equations are formed as:

$$\frac{{V}_{0}}{{V}_{1}} = \frac{\sqrt{{( x - {x}_{i} )}^{2} + {( y - {y}_{i} )}^{2} + {( z - {z}_{i} )}^{2}}}{\sqrt{{( x - {x}_{i} )}^{2} + {( y - {y}_{i} )}^{2} + {( z - {z}_{i} )}^{2}}}$$

These equations form a nonlinear system that can be solved through numerical optimization (e.g., nonlinear least squares or gradient-based algorithms), enabling precise estimation of the object's 3D position.

Of course, motion is simply a change of position. The system may thus track changes of position by periodically recomputing the object's 1220 position based on the relative sensed signal strengths.

A system implementation of this embodiment may use any known processor or processing system 1240 or computing platform that executes code stored in any volatile or non-volatile storage device to perform the computations shown above for determining position and thus motion. For example, a position-determining software module 1250 is shown in FIG. 11 to perform the calculations needed to determine the object's 1220 position—either 2D or 3D depending on the implementation—as described above. The outputs of the DiCe circuits/sensors may be acquired and converted into a form for digital processing in any known manner, for example through analog-to-digital conversion 1230, possibly after amplification and noise filtering as deemed necessary. The resulting position of the object 1220 may then be used for any desired purpose, including display on a screen or as an input to another system.

As mentioned, at least three DiCe sensors are needed to determine an electrostatically charged object's position, but even a single sensor may be used to sense the presence of a charged object, and its motion relating to the sensor: As long as the current induced in the DiCe diode(s) exceeds a pre-determine threshold, the system may indicate that the charged object is at least within measurable sensing range and whether the object is moving closer or farther away from the sensor. Similarly, the relative output signal strengths of only two DiCe sensors would be able to determine the charged object's position on a hyperbolic path between the sensors.

In all of these embodiments that determine position and/or motion relative to DiCe sensing elements, the accuracy of the determinations may optionally be improved through precise calibration of the sensors, for example, with respect to their output voltages for objects whose electrostatic charges are measured with conventional instruments and with predetermined motions and velocities of the object within the sensing space. The calibrations may then provide correction values than can be used in the formulas above.

1. An energy harvesting system for converting energy from mechanical motion into electrical energy, comprising:
at least one diode cell comprising at least one diode having a junction;
each said diode cell being placed on a respective carrier;
each said diode cell producing an induced current in response to a potential difference across said junction when in proximity to a charged object that has a dynamically changing electrostatic field; and
electrical connections configured to conduct the induced current from each said diode cells to a load;
each said diode cell producing the induced current independent of alignment of motion vectors of the charged object with the respective diode junction.

2. The system of claim 1, in which each diode cell comprises at least one series-connected plurality of the diodes.

3. The system of claim 2, in which at least one of the diode cells comprises a plurality of parallel-connected ones of the series-connected plurality of the diodes.

4. The system of claim 1, comprising a plurality of the diode cells in which the plurality of diodes cells are arranged non-planar, whereby the diodes in the plurality of diode cells produce induced current in a three-dimensional electrostatic field space.

5. The system of claim 1, in which the diodes of at least one of the diode cells are configured on a non-planar substrate, the plurality of diodes in the diode cells thereby producing induced current while being located at different distances in three dimensions from the charged object.

6. The system of claim 1, in which at least one of the diode cells is implanted within a patient, the load is a device implanted in the patient, the at least one diode cell is electrically connected to provide electrical current for use to power the implanted device, in which the electrical current is induced in the diodes of the at least one diode cell by moving the charged object external to the patient.

7. The system of claim 1, in which at least one of the diode cells is mounted on a carrier that is wearable by a user.

8. The system of claim 1, in which:
the diode cells are mounted at known positions in a multi-dimensional space;
the charged object is located at a position within the multi-dimensional space;
the system further including:
a processing system including a position-determining module receiving output signals from the diode cells and computing the position P as a function of values of the output signals.

9. A method for harvesting energy by converting energy from mechanical motion into electrical energy, comprising:
arranging at least one diode having a junction as at least one diode cell;
mounting the at least one diode cell on a carrier;
said diode cell(s) producing an induced current in response to a potential difference across said junction when in proximity to a charged object that has a dynamically changing electrostatic field; and
conducting the induced current from said diode cell(s) to a load;
said diode cell(s) producing the induced current independent of alignment of motion vectors of the charged object with the diode junctions.

10. The method of claim 9, comprising configuring each diode cell to include at least one series-connected plurality of the diodes.

11. The method of claim 10, comprising configuring at least one of the diode cells as a plurality of parallel-connected ones of the series-connected plurality of the diodes.

12. The method of claim 9, comprising arranging a plurality of the diode cells to be located at different non-planar positions, whereby the diodes in the plurality of diode cells produce induced current in a three-dimensional electrostatic field space.

13. The method of claim 9, comprising configuring the diodes of at least one of the diode cells are on a non-planar substrate, the plurality of diodes in the diode cells thereby producing induced current while being located at different distances in three dimensions from the charged object.

14. The method of claim 9, comprising implanting at least one of the diode cells within a patient and electrically connecting the diode cell to provide electrical current for use to operate an implanted device, in which the electrical current is induced in the diodes of the at least one diode cell by moving the charged object external to the patient.

15. The method of claim 9, comprising mounting at least one of the diode cells on a carrier that is wearable by a user.

16. The method of claim 9, comprising:
mounting the diode cells at known positions in a multi-dimensional space;
the charged object is located at a position within the multi-dimensional space;
the method further including receiving output signals from the diode cells and computing a position of the charged object within the multi-dimensional space as a function of values of the output signals.
